(19) United States
(12) Patent Application Publication
(10) Pub. No.: US 2004/0034143 A1
(43) Pub. Date: Feb. 19, 2004

(54) Plastisol composition and method for using same

(76) Inventors: James Hubert, Brookfiled, WI (US); Feliks Habjanic, Menomee Falls, WI (US)

Correspondence Address: HENKEL CORPORATION, THE TRIAD, SUITE 200, 2200 RENAISSANCE BLVD., GULPH MILLS, PA, 19406, US

(21) Appl. No.: 10/297,186

(22) PCT Filed: May 17, 2001
(86) PCT No.: PCT/US01/16003

(51) Int. Cl. C08L 1/00

(52) U.S. Cl. 524/418; 524/543; 524/563

(57) ABSTRACT

A composition useful as a sealant in the automotive industry, particularly the paint shop area, is provided which comprises a plastisol, an amine-containing adhesion promoter, and, an acid catalyst other than dinonyl napthylene disulfonic acid. The composition when topcoated with an acid catalyzed topcoat, i.e., paint, during its application in the automobile assembly and particularly areas that have not been readily overcoated will provide a topcoat possessing a non-tacky surface.

### BACKGROUND OF THE INVENTION

1. Technical Field

This disclosure relates generally to a plastisol composition and method for using same. More specifically, the plastisol composition described herein contains at least a plastisol, e.g., a polyvinyl chloride (PVC) resin and a plasticizer, an amine-containing adhesion promoter and an acid catalyst. Methods for its use as a sealant in the automotive industry are also described.

2. Background of Related Art

Plastisols are widely used in many industrial processes as adhesives and sealers. See, e.g., U.S. Pat. Nos. 4,146,520; 4,151,317; 4,268,548; 4,440,900; 4,533,524; 4,673,710; 4,851,464; 4,900,771; 4,988,768; 5,032,432; 5,039,768; 5,130,200; 5,143,650; 5,160,628; 5,205,963; and 5,248,562. In general, adhesives are employed to bind various substrates together while sealants are employed to produce load bearing elastic joints between two or more surfaces and to prevent the passage of air, water and dirt therethrough. The automotive industry, in particular, is a major user of both the adhesives and sealants. Automobiles are assembled from several structural components which are joined together in various fashions depending on particular components and the degree of stress that will have to be endured. For certain assembly steps an adhesive composition is applied as a liquid and subsequently hardened to provide sufficient bonding strength. For example, adhesives are utilized in the assemblies of door panels, quarter panels, tailgates and roofs. These same assemblies will typically employ sealant compositions at a later stage in the assembly line. Still other automobile assemblies which are welded or bolted together use sealant compositions in their seams. The wheel house, shock tower, rocker panel, firewall, floor hem flange, floorplan, and trunk are a few examples of where sealants, but not adhesives, are employed.

Typically, automobile body assembly lines contain separate body shop and paint shop areas where adhesives and sealants are individually employed in each respective area. Adhesive compositions applied in the body shop area can be high strength epoxy or modified-epoxy adhesives which are capable of bonding to oily galvanized steel. In some cases, vinyl plastisols can be employed, however, these applications are normally limited to situations that do not require high bonding performance. In any case, these materials are applied at room temperature and later cured through exposure to heat. In order to apply these materials, they must be of low enough viscosity to be mechanically pumped with adequate flow rates. Normally, because of their low viscosity these materials are easily displaced when exposed to liquid impingement by various cleaning solutions (washes) to which the assembly body parts are exposed. Once the assembled parts are moved from the body shop area to the paint shop area, they are subjected to sealing, topcoating (painting), and final oven curing. Sealant compositions have been found to have those needed characteristics.

Plastisols have been employed as sealants in the paint shop area of the body assembly line. The plastisols adhere well to primed metal surfaces and can be painted over. They are durable enough to withstand normal weather and user exposure. Another important quality of the plastisols is that they are not expensive. In general, plastisols, are dispersions of polymeric resins in plasticizers. Examples of such polymeric resins include poly(vinyl chloride), poly(vinyl acetate) and copolymers of vinyl chloride and vinyl acetate. Other polymers can be employed as well in the preparation of plastisols. Plasticizers are high boiling liquids which attack and plasticize the polymeric resin particles. The plastisols are liquids which are applied at room temperature to the substrate. The liquid is converted to a solid through exposure to heat. In effect, the heat causes the dispersed resin particles to fuse together or dissolve into the plasticizer. A solid product results upon subsequent cooling.

Typically, in the manufacture of automobiles, the automobile body is initially primed with a coating composition to prevent corrosion of the metal. This can be performed in a number of ways, e.g., by cationic electrodeposition using the auto body as the cathode. Once the automobile body has been primed in this manner, subsequent steps in the assembly are carried out. These steps include the use of plastisols as sealants over the primed automobile body. The sealants are subsequently topcoated with an acid catalyzed topcoat along with the remainder of the body during the final stages of the topcoating (painting) process. Certain areas of the body, however, are not readily overcoated with the topcoat and instead only contain a thin film, i.e., overspray, during the topcoating process.

Amine-containing adhesion promoters have been employed in plastisol compositions to improve the adhesion of the plastisol to the various parts of the automobile body it is applied thereto. Examples of such amine-containing adhesion promoters are those disclosed in U.S. Pat. Nos.4,533,524; 4,824,700; 4,8511,464; 5,650,482; and 6,040,385.

One problem associated with the prior art plastisol compositions employing an amine-containing adhesion promoter is that following the plastisol sealant being applied to the primed automobile body part and the subsequent topcoating with an acid catalyzed topcoat thereon and, particularly, in the areas that are not readily overcoated, i.e., areas containing only an overspray or low film build of the topcoat, the amine-containing adhesion promoter interacts and renders ineffectual the acid catalyst in the topcoat by neutralizing the acid catalyst resulting in the topcoat possessing a tacky surface. Therefore, use of a clear coat not normally used in these areas is applied over the topcoat to provide a non-tacky surface.

Accordingly, there is a need for improvement in formulating a plastisol composition whereby when topcoating the plastisol composition the acid catalyzed topcoat possesses a non-tacky surface and, therefore, use of a clear coat is not necessary to effect a non-tacky surface.

### SUMMARY OF THE INVENTION

It is an object of the present invention to provide a PVC plastisol composition that interacts with an acid catalyzed topcoat applied thereon thereby resulting in the topcoat possessing a non-tacky surface over a wide range of temperatures.

In accordance with the present invention, the foregoing plastisol composition comprises:

a) at least one plastisol;

b) an amine-containing adhesion promoter; and,

c) an acid catalyst other than dinonyl napthylene disulfonic acid.

Further in accordance with the present invention, a method for providing a topcoat possessing a non-tacky surface on a substrate is provided which comprises the steps of applying the aforestated plastisol composition to the substrate; and, applying an acid catalyzed topcoat thereon.

By employing an acid catalyst in the plastisol composition herein, the ability to overcoat the plastisol wet-on-dry or wet-on-wet with an acid catalyzed topcoat to provide a non-tacky surface is achieved and particularly in areas that have not been readily overcoated, e.g., at thicknesses ranging from about 0.0015 inches to about 0.0065 inches, while also allowing for excellent adhesion characteristics of the plastisol. These and other advantages will be readily apparent to those skilled in the art based upon the disclosure contained herein.

### DESCRIPTION OF THE PREFERRED EMBODIMENTS

The plastisol composition of this invention is obtained by mixing at least one plastisol, an amine-containing adhesion promoter, and an acid catalyst other than dinonyl napthylene disulfonic acid. The composition is based on the surprising discovery that the addition of an acid catalyst thereto will enable a topcoat to possess a non-tacky surface when applied on the plastisol composition of this invention during its application as a sealant and, in particular, areas where the topcoat was not readily applied, i.e., applied as an overspray. While not wishing not to be bound by theory, it is believed that a significant amount of the adhesion promoter migrates to the surface of the cured plastisol. The migration does not adversely impact the performance of the plastisol as a sealant but it does adversely affect the curability of acid catalyzed topcoats which are then applied to the wet (wet-on-wet) or dry (wet-on-dry) plastisol. It is believed that the amine adhesion promoter in the sealant reacts with the acid catalyst in the topcoat, neutralizes it, and rendering it ineffective for catalyzing the topcoat. This means that the topcoat will not be fully cured resulting in a tacky surface of the topcoat. Thus, it has been found that by adding an excess of acid catalyst directly to the plastisol sealant, we are able to overcome the neutralizing effects of the amine such that the acid catalyst in the sealant will crosslink with the resins in the topcoat resulting in a non-tacky surface.

In general, the plastisols employed in the composition of the present invention comprises finely divided resin particles dispersed in a plasticizer. The resins are well known in the art and have been widely used in plastisol compositions. Suitable resins for use herein include polyvinyl chloride resins, polyvinyl acetate resins, copolymers of vinyl chloride with vinyl addition monomers such as, for example, vinyl acetate, the vinyl acetals, maleic esters, styrene, vinylidene chloride and acrylonitrile. Particularly preferred polyvinyl chloride resins are the polyvinyl chloride homopolymers. Blends of several different polyvinyl chloride resins can also be used and will also be referred to as the polyvinyl chloride resin, even though more than one resin may actually be present. Generally, a blend of from about 50 to about 100 percent and most preferably from about 60 to about 75 percent of a homopolymer dispersion resin can be used herein.

Plasticizers useful in the production of the plastisol include monomeric types selected to achieve desired characteristics such as proper gelation, fusion, and flow properties. Examples of such monomeric plasticizers include monomeric esters of phthalic, benzoic, succinic, adipic, sebacic, talic, lauric, azelaic, caprylic, hexanoic, phosphoric, oleic, glutaric, trimellitic and stearic acids. Specific plasticizers include dioctyl phthalate, ethylene glycol dibenzoate, dioctyl succinate, dibutyl sebacate; dibenzyl azelate, didecyl glutarate and similar compounds. Other monomeric plasticizers include esters of 2,2,4-trimethyl-1,3-pentanediol, citric acid esters and N-ethyl toluenesulfonamide. A preferred plasticizer for use herein is diisodecyl phthalate.

Polymeric plasticizing agents can be used in conjunction with the monomeric plasticizers in order to achieve special characteristics such as permanence, weathering resistance, and especially paintability. Polymer plasticizers useful in the present invention include the higher molecular weight polymeric acid esters (molecular weights greater than 1000). Examples of these polymeric plasticizers include esters of succinic, adipic, sebacic, talic, lauric, azelaic, caprylic, hexanoic, benzoic, phthalic, phosphoric, oleic, glutaric, trimellitic, and stearic acids, including mixtures or blends of these compounds. The polymeric plasticizers ordinarily have low diffusion rates because of their higher molecular weights and also act to retard the migration of other components from the applied compositions. Additionally, low molecular weight chlorinated paraffinic oils and epoxidized soybean oil can be used as co-plasticizers. Blends of several different plasticizers can be used, but will be referred to simply as the plasticizer.

Suitable amine-containing adhesion promoters can be any commercially available amine-containing adhesion promoters known to one skilled in the art. Representative of the amine-containing adhesion promoters include those disclosed in U.S. Pat. Nos. 4,533,524; 4,673,710; 4,717,746; 4,824,700; 4,851,464; 5,650,482; and 6,040,385, the contents of which are incorporated by reference herein. Useful amine-containing adhesion promoters for use herein include, for example, monoamide compounds, polyamide compounds, polyoxyalkylene polyamines, oxyalkylene ethers of mono- or polyamines, epoxy-modified products of one or more of these compounds, mixtures thereof and the like.

Suitable monoamines include aliphatic, aromatic, araliphatic and alicyclic monoamines such as, for example, alkyl amines with the alkyl group containing from 1 to about 20 carbon atoms, e.g., methyl, ethyl, propyl, isopropyl, butyl, octyl, lauryl amines, etc., aniline, toluidine, naphthyl amines, benzyl amine, cyclohexyl amine and the like. Suitable polyamines include aliphatic, aromatic, araliphatic and alicyclic polyamines such as, for example, alkylene diamines, e.g., ethylene, propylene, hexamethylene diamines, etc., and the like.

Suitable polyoxyalkylene polyamines include ones obtainable by converting the terminal hydroxyl groups of polyether polyols into amino groups by, for example, ammonolysis. Examples of suitable polyether polyols are polyoxyalkylene diols, triols, tetraols and the like, obtained by adding alkylene oxides such as, for example, ethylene glycol, propylene glycol, diethylene glycol, glycerol, trimethlol propane, ethylene diamine and the like, to initiators. Illustrative of polyoxyalkylene polyamines are those represented by the general formulae (1) and (2):

H₂N—A(OA)ₙNH₂ (1)

X[(OA)ₘNH₂)]₃ (2)

wherein A represents an alkylene group having from 2 to about 12 carbon atoms, e.g., a propylene group, X represents the residue of triol such as trimethylol propane, n is an integer of about 2-50 and m is an integer about 3-50. Useful polyoxyalkylene polyamines include polyoxypropylene polyamines (diamines or triamines) derived from polypropylene glycols or polyoxypropylene triols and the like.

Oxyalkylene ethers of mono- or polyamines can be obtained by adding one or more of the foregoing alkylene oxides to one or more of the aforestated mono- or/and polyamines. Illustrative of suitable amines are alkanol amines such as di- and tri-ethanol amines and the like; (poly)ethylene polyamines such as ethylene diamine, diethylene triamine, triethylene tetramine, tetraethylene pentamine, pentaethylene hexamine and the like; (poly)propylene polyamines such as propylene diamine, dipropylene triamine, tripropylene tetramine and the like; (poly)cycloalkylene polyamine such as 1,8-p-menthane diamine, isophorone diamine, cyclohexylene diamines, 4,4′-dicyclohexylmethane diamines, 1,3-bis(aminomethyl)cyclohexane and the like. Among these, preferred are triethanol amine, ethylene diamine, diethylene triamine and dipropylene triamine. Among alkylene oxides, preferred are ethylene oxide, propylene oxide and combinations thereof with the alkylene oxides being in block sequencing, random sequencing or a combination of both block and random sequencing. Equivalent weight of oxyalkylene ethers of mono- or polyamines is usually at least about 30 and preferably about 60-500.

Suitable epoxy-modified amines include, for example, ones obtainable by modifying one or more of these compounds such as, for example, polyoxyalkylene polyamines, oxyalkylene mono-or polyamines, ketimines of amino-compounds, etc., with one or more epoxy compounds. Suitable epoxy compounds include glycidyl ethers, e.g., bisphenol A glycidyl ether, polypropyleneglycol diglycidyl ether, phenyl glycidyl ether etc.; glycidyl esters such as dimeric acid glycidyl ester and the like; glycidyl amines such as tetraglycidyl diamino diphenyl methane and the like; linear aliphatic epoxides such as epoxydized polybutadienes and the like; alicyclic epoxides such as 3,4-epoxy-6-methylcyclohexylmethylcarboxylate; and the like. Among these, preferred are glycidyl ethers.

Suitable acid catalysts other than dinonyl napthylene disulfonic acid for use in the plastisol composition of this invention can include any strong acid such as, for example, a sulfonic acid other than dinonyl napthylene disulfonic acid, e.g., amine blocked sulfonic acids, that can interact with an acid catalyzed topcoat applied on the composition thereby resulting in the topcoat possessing a non-tacky surface. Examples of sulfonic acids include paratoluene sulfonic acid, methyl sulfonic acid, ethyl sulfonic acid, propyl sulfonic acid, isopropyl sulfonic acid, butyl sulfonic acid, pentyl sulfonic acid, hexyl sulfonic acid, heptyl sulfonic acid, octyl sulfonic acid, nonyl sulfonic acid, decyl sulfonic acid, benzene sulfonic acid and the like with paratoluene sulfonic acid being preferred. Other examples of acid catalysts for use herein include catalysts in the Nacure series available from King Industries (Norwalk, Conn.). Of these acid catalysts, Nacure® 2547 is most preferred for use herein.

The plastisol composition of this invention will ordinarily range from about 10 to about 40 weight percent of the finely divided resin, from about 20 to about 50 weight percent of the plasticizer, from about 0.1 to about 2.5 weight percent of the amine-containing adhesion promoter and from about 0.1 to about 2 weight percent of the acid catalyst, preferably from about 20 to about 35 weight percent of the finely divided resin, from about 25 to about 40 weight percent of the plasticizer, from about 0.5 to about 2 weight percent of the amine-containing adhesion promoter and from about 0.5 to about 1.5 weight percent of the acid catalyst and more preferably from about 25 to about 30 weight percent of the resin, from about 30 to about 35 weight percent of the plasticizer, from about 1 to about 1.5 weight percent of the amine-containing adhesion promoter and from about 0.75 to about 1 weight percent of the acid catalyst.

The plastisol composition of this invention can also include optional components such as other adhesion promoters, e.g., methacrylates, epoxies, phenolic resins, silanes and the like; fillers, e.g., ground calcium carbonate, calcium sulfate, calcium oxide, magnesium oxide, titanium oxide, zinc oxide, diatomaceous earth, and the like; pigments, e.g., carbon black, titanium dioxide and the like; wetting agents, e.g., polyethylene glycol derivatives and the like, oil-absorbing substances, e.g., diatomaceous earth and the like, tackifiers, e.g., nitrile rubber, styrene butadiene, resin esters, tepene resins, and the like, rheological additives, e.g., precipitated calcium carbonates, silicas, clay derivatives and the like, waxes, e.g., castor wax, amorphous wax, beeswax, carnauba wax, spermaceti wax, vegetable wax, candililla wax, japan wax, ouricury wax, douglas-fir bark wax, rice-bran wax, jojoba wax, bayberry wax, montan wax, peta wax, ozokerite wax, ceresin wax, petroleum wax, paraffin wax, polyethylene wax, fischer-tropsch wax, chemically modified hydrocarbon wax, substituted amide wax and the like; and solvents, e.g., mineral spirits, xylene, toluene, and the like. In general, the amount of these optional components will vary from about 20 to about 50 weight percent and preferably from about 25 to about 30 weight percent of the composition.

The plastisol composition of this invention is particularly useful as a sealant in the assembly of automotive bodies. Thus, the composition of this invention can be used in the paint shop area of the assembly and is applied to a substrate that is typically primed with a corrosion-inhibiting coating prior to the composition being applied thereto. For example, the composition can be used for substrates such as metal assemblies of door panels, quarter panels, tailgates and roofs that leave the body shop area. Additionally, the sealant composition can be used for other automobile assemblies which are welded or bolted together and use the sealant compositions in their seams. Such assemblies include substrates such as the wheel house, shock tower, rocker panel, firewall, floor hem flange, floorplan, hood and trunk.

In general, the sealant composition can be applied to any of the foregoing substrates at room temperature in any convenient manner, such as pumping, troweling, flowing, brushing or spraying, either manually or robotically. The plastisol can then be baked, e.g., raising the temperature to a range of from about 130° C. to about 160° C., such that upon cooling the sealant composition hardens to a state with an initial degree of sealing which is adequate for the intended purpose, topcoated (wet-on-dry) and then cured at a temperature from about 250° F. to about 350° F. such that the catalyst in the sealant crosslinks with the topcoat and driving off the solvent. Alternatively, the plastisol can be applied followed by the topcoat wherein both coatings are cured in a single bake (wet-on-wet), e.g., at a temperature ranging from about 250° F. to about 350° F. Accordingly, the substrate is topcoated with an acid catalyzed topcoat with some areas possessing only an overspray and oven baked to a totally cured state by plastisol fusion of the sealer and also the topcoat paint. Typical topcoats include, for example, high performance acrylic topcoats which are cured by conventional acid catalysts. The applied composition of this invention is also able to withstand these operations without causing cosmetic-type problems such as discoloration, cracking, etc. After the sealant composition is painted over, the final product will have a smooth finish with substantially no tackiness or transfer where the topcoat was applied.

The following non-limiting examples are illustrative of this invention.

### EXAMPLE 1

To a mixing vessel, a mixture of 10.49 grams of linear dinonyl phthalate plasticizer, 5.14 grams of diisoheptyl phthalate plasticizer, 10.52 grams of polyester adipate plasticizer, 1.51 grams vinyl chloride-vinyl acetate-maleic acid terpolymer, 4.28 grams of m,p-cresol propoxylate, 1.21 grams of precipitated silica, 0.11 grams glycerine, 14.29 grams ground calcium carbonate, 15.07 grams precipitated calcium carbonate, 15.52 grams PVC resin, 15.52 grams vinyl chloride-vinyl acetate copolymer, 1.61 grams polyamidoamine, 0.25 grams blocked isocyanate, 1.46 grams calcium sulfonate plasticizer, 2.02 grams of glass beads (hollow glass microspheres) and 1.00 grams of Nacure® 2547 available from King Industries (Norwalk, Conn.) was formed. After mixing was commenced, the mixing continued under vacuum for a period of 30 minutes to provide the plastisol composition within the scope of this invention.

### EXAMPLE 2

The PVC plastisol of Example 1 was applied to electrodeposition coated metal panels as a sealant at thickness of 0.04″ and baked for 30 minutes at 270° F. The baked panels were further baked for an additional 30 minutes at 270° F. The sealant was then cooled until it reached room temperature.

The electrodeposition coated metal panels were then painted with an acid catalyzed topcoat at different thicknesses as shown below in Table 1 over the area where the sealant was applied. The topcoat was then evaluated for paint tack and transfer by touching the painted surface with a finger and noting the paint tack or transfer of the paint. These results are summarized below in Table 1.

TABLE 1

| Thickness of | Results |
|---|---|
| 0.001″ | No tack or transfer |
| 0.0007″ | No tack or transfer |
| 0.0005″ | No tack or transfer |
| 0.0003″ | No tack or transfer |
| 0.0002″ | Tackiness, no |
| | transfer |

### EXAMPLE 3

The PVC plastisol of Example 1 was applied to electrodeposition coated metal panels as a sealant at a thickness of 0.04″ and baked for 30 minutes at 270° F. The baked panels were further baked for an additional 30 minutes at 270° F. The sealant was then cooled until it reached room temperature.

The electrodeposition coated metal panels were then painted with an acid catalyzed topcoat at different thicknesses as shown below in Table 1 over the area where the sealant was applied. The topcoat was then evaluated for paint tack and transfer by touching the painted surface with a finger and noting the paint tack or transfer of the paint. These results are summarized below in Table 2.

TABLE 2

| Thickness of | Results |
|---|---|
| 0.001″ | No tack or transfer |
| 0.0007″ | No tack or transfer |
| 0.0005″ | No tack or transfer |
| 0.0003″ | No tack or transfer |
| 0.0002″ | No tack or transfer |

### EXAMPLE 4

The PVC plastisol of Example 1 was again applied to electrodeposition coated metal panels as a sealant at a thickness of 0.04″ and baked for 30 minutes at 270° F. The baked panels were further baked for an additional 30 minutes at 270° F. The sealant was then cooled until it reached room temperature.

The electrodeposition coated metal panels were then painted with an acid catalyzed topcoat at different thicknesses as shown below in Table 2 over the area where the sealant was applied. The topcoat was then evaluated for paint tack and transfer by touching the painted surface with a finger and noting the paint tack or transfer of the paint. These results are summarized below in Table 3

TABLE 3

| Thickness of | Results |
|---|---|
| 0.001″ | No tack or transfer |
| 0.0007″ | No tack or transfer |
| 0.0005″ | No tack or transfer |
| 0.0003″ | No tack or transfer |
| 0.0002″ | No tack or transfer |

### Comparative Example A

To a mixing vessel, a mixture of 11.49 grams of linear dinonyl phthalate plasticizer, 5.14 grams of diisoheptyl phthalate plasticizer, 10.52 grams of polyester adipate plasticizer, 1.51 grams vinyl chloride-vinyl acetate-maleic acid terpolymer, 4.28 grams of m,p-cresol propoxylate, 1.21 grams of precipitated silica, 0.11 grams glycerine, 14.29 grams ground calcium carbonate, 15.07 grams precipitated calcium carbonate, 15.52 grams PVC resin, 15.52 grams vinyl chloride-vinyl acetate copolymer, 1.61 grams polyamidoamine, 0.25 grams blocked isocyanate, 1.46 grams calcium sulfonate plasticizer, and 2.02 grams of glass beads (hollow glass microspheres) was formed. After mixing was commenced, the mixing continued under vacuum for a period of 30 minutes to provide the plastisol composition outside the scope of this invention.

### Comparative Example B

The PVC plastisol of Comparative Example A was applied to electrodeposition coated metal panels as a sealant at thickness of 0.04″ and baked for 30 minutes at 270° F. The baked panels were further baked for an additional 30 minutes at 270° F. The sealant was then cooled until it reached room temperature.

The electrodeposition coated metal panels were then painted with an acid catalyzed topcoat at different thicknesses as shown below in Table 4 over the area where the sealant was applied. The topcoat was then evaluated for paint tack and transfer by touching the painted surface with a finger and noting the paint tack or transfer of the paint. These results are summarized below in Table 4.

TABLE 4

| Thickness of | Results |
|---|---|
| 0.001″ | No tack or transfer |
| 0.0007″ | No tack or transfer |
| 0.0005″ | Tackiness |
| 0.0003″ | Tackiness |
| 0.0002″ | Transfer |

As these data show, when applying an acid catalyzed topcoat onto a substrate that has a sealant composition of Examples 2-4 (within the scope of this invention) applied thereon, and particularly in the areas containing only an overspray of the topcoat, no tackiness or transfer was evident. In contrast, Comparative Example B illustrates that when a topcoat is applied onto a substrate containing a sealant composition outside the scope of this invention tackiness and/or transfer occurred in the areas that contained only an overspray.

Although the present invention has been described in preferred forms with a certain degree of particularity, many changes and variations are possible therein and will be apparent to those skilled in the art after reading the foregoing description. It is therefore to be understood that the present invention may be practiced otherwise than as specifically described herein without departing from the spirit and scope thereof.

What is claimed is:

1. A composition useful as a sealant in the assembly of automobile bodies comprising:
at least one plastisol;
an amine-containing adhesion promoter; and,
an acid catalyst other than dinonyl napthylene disulfonic acid.

2. The composition of claim 1 wherein the plastisol comprises a polymeric resin and a plasticizer.

3. The composition of claim 2 wherein the polymeric resin is selected from the group consisting of poly(vinyl chloride), poly(vinyl acetate), copolymers of vinyl chloride, vinyl acetate and mixtures thereof.

4. The composition of claim 2 wherein the plasticizer is selected from the group consisting of monomeric esters of phthalic, benzoic, succinic, adipic, sebacic, talic, lauric, azelaic, caprylic, hexanoic, phosphoric, oleic, glutaric, trimellitic and stearic acids, 2,2,4-trimethyl-1,3-pentanediol, citric acid esters, N-ethyl toluenesulfonamide, polymeric esters of succinic, adipic, sebacic, talic, lauric, azelaic, caprylic, hexanoic, benzoic, phthalic, phosphoric, oleic, glutaric, trimellitic and stearic acids, and mixtures thereof.

5. The composition of claim 1 wherein the amine-containing adhesion promoter is selected from the group consisting of monoamide compounds, polyamide compounds, polyoxyalkylene polyamines, oxyalkylene ethers of mono- or polyamines, epoxy-modified compounds of one or more monoamide compounds, polyamide compounds, polyoxyalkylene polyamines, oxyalkylene ethers of mono- or polyamines, and mixtures thereof.

6. The composition of claim 1 wherein the acid catalyst is a sulfonic acid.

7. The composition of claim 6 wherein the sulfonic acid is selected from the group consisting of paratoluene sulfonic acid, methyl sulfonic acid, ethyl sulfonic acid, propyl sulfonic acid, isopropyl sulfonic acid, butyl sulfonic acid, pentyl sulfonic acid, hexyl sulfonic acid, heptyl sulfonic acid, octyl sulfonic acid, nonyl sulfonic acid, decyl sulfonic acid and benzene sulfonic acid.

8. The composition of claim 1 wherein the acid catalyst is paratoluene sulfonic acid.

9. The composition of claim 1 wherein the amount of acid catalyst represents from about 0.1 to about 2 weight percent of the composition.

10. The composition of claim 8 wherein the amount of acid catalyst represents from about 0.1 to about 2 weight percent of the composition.

11. The composition of claim 2 wherein the polymeric resin represents from about 10 to about 40 weight percent, the plasticizer represents from about 20 to about 50 weight percent and the amine-containing adhesion promoter represents from about 0.1 to about 2.5 weight percent of the composition.

12. The composition of claim 1 further comprising optional components selected from the group consisting of adhesion promoters other than the amine-containing adhesion promoters, fillers, pigments, wetting agents, oil-absorbing substances, tackifiers, rheological additives, waxes, solvents and mixtures of one or more thereof.

13. The composition of claim 12 wherein the optional components represents from about 20 to about 50 weight percent of the composition.

14. A method for providing a topcoat possessing a non-tacky surface on one or more substrates comprising the steps of applying the plastisol composition of claim 1 to the substrate; and, applying an acid catalyzed topcoat thereon.

15. The method of claim 14 wherein the substrate comprises an automobile body or part.

16. The method of claim 15 wherein the automobile body or part is selected from the group consisting of a door panel, quarter panel, tailgate, roof, wheel house, shock tower, rocker panel, firewall, floor hem flange, floorplan, hood and trunk.

17. The method of claim 14 wherein the plastisol comprises a polymeric resin and a plasticizer.

18. The method of claim 17 wherein the polymeric resin is selected from the group consisting of poly(vinyl chloride), poly(vinyl acetate), copolymers of vinyl chloride, vinyl acetate and mixtures thereof.

19. The method of claim 17 wherein the plasticizer is selected from the group consisting of monomeric esters of phthalic, benzoic, succinic, adipic, sebacic, talic, lauric, azelaic, caprylic, hexanoic, phosphoric, oleic, glutaric, trimellitic and stearic acids, 2,2,4-trimethyl-1,3-pentanediol, citric acid esters, N-ethyl toluenesulfonamide, polymeric esters of succinic, adipic, sebacic, talic, lauric, azelaic, caprylic, hexanoic, benzoic, phthalic, phosphoric, oleic, glutaric, trimellitic and stearic acids, and mixtures thereof.

20. The method of claim 14 wherein the amine-containing adhesion promoter is selected from the group consisting of monoamide compounds, polyamide compounds, polyoxyalkylene polyamines, oxyalkylene ethers of mono- or polyamines, epoxy-modified compounds of one or more monoamide compounds, polyamide compounds, polyoxyalkylene polyamines, oxyalkylene ethers of mono- or polyamines, and mixtures thereof.

21. The method of claim 14 wherein the acid catalyst is a sulfonic acid.

22. The method of claim 21 wherein the sulfonic acid is selected from the group consisting of paratoluene sulfonic acid, methyl sulfonic acid, ethyl sulfonic acid, propyl sulfonic acid, isopropyl sulfonic acid, butyl sulfonic acid, pentyl sulfonic acid, hexyl sulfonic acid, heptyl sulfonic acid, octyl sulfonic acid, nonyl sulfonic acid, decyl sulfonic acid and benzene sulfonic acid.

23. The method of claim 14 wherein the acid catalyst is paratoluene sulfonic acid.

24. The method of claim 14 wherein the amount of acid catalyst represents from about 0.1 to about 2 weight percent of the composition.

25. The method of claim 23 wherein the amount of acid catalyst represents from about 0.1 to about 2 weight percent of the composition.

26. The method of claim 15 wherein the polymeric resin represents from about 10 to about 40 weight percent, the plasticizer represents from about 20 to about 50 weight percent and the amine-containing adhesion promoter represents from about 0.1 to about 2.5 weight percent of the composition.

27. The method of claim 14 further comprising optional components selected from the group consisting of adhesion promoters other than the amine-containing adhesion promoters, fillers, pigments, wetting agents, oil-absorbing substances, tackifiers, rheological additives, waxes, solvents and mixtures of one or more thereof.

28. The method of claim 27 wherein the optional components represents from about 20 to about 50 weight percent of the composition.

29. The method of claim 14 wherein the topcoat is applied to the substrate at a thickness of about 0.0015 inches to about 0.0065 inches.

30. The method of claim 14 further comprising the step of curing the topcoat at a temperature from about 250° F. to about 350° F.
